(19) United States
(12) Patent Application Publication
(10) Pub. No.: US 2019/0012866 A1
(43) Pub. Date: Jan. 10, 2019

(54) DEVICE AND METHOD FOR EXAMINING DOCUMENTS OF VALUE AND/OR TRANSPORTING DOCUMENTS OF VALUE BY MEANS OF ULTRASOUND

(71) Applicant: GIESECKE+DEVRIENT CURRENCY TECHNOLOGY GMBH, München (DE)

(72) Inventor: Hans-Uwe MOOSLER, München (DE)

(21) Appl. No.: 15/746,975

(22) PCT Filed: Jul. 29, 2016
(86) PCT No.: PCT/EP2016/001324

§ 371 Date: Jan. 23, 2018

(30) Foreign Application Priority Data
Jul. 30, 2015 (DE) 10 2015 009 899.3

(51) Int. Cl. G07D 7/08; G07D 7/164; G07D 11/00; G07D 7/20; G07D 7/162

(52) U.S. Cl. CPC G07D 7/08; G07D 7/164; G07D 7/162; G07D 11/0021; G07D 7/2075; G07D 11/0084

(57) ABSTRACT

Described is a device for examining value documents and/or the transport of value documents which are transported along a specified transport path in a specified transport direction, by means of ultrasound with ultrasound transmitters disposed offset in a direction transverse to the transport direction for emitting, upon transmit signals, ultrasound on the transport path and ultrasound receivers disposed offset in a direction transverse to the transport direction for receiving ultrasound which is generated by means of the ultrasound transmitters, and for emitting receive signals, the ultrasound transmitters and/or ultrasound receivers respectively having at least one capacitive, micromechanical ultrasonic transducer.

The present invention relates to a device and a method for examining value documents and/or the transport of value documents by means of ultrasound.

Value documents are understood here to be card- or preferably sheet-shaped objects that represent for example a monetary value or an authorization and hence should not be producible arbitrarily by unauthorized persons. Hence, they have features that are not easily produced, in particular copied, whose presence is an indication of authenticity, i.e. production by an authorized body. Important examples of such value documents are chip cards, coupons, vouchers, checks and in particular bank notes.

Such value documents are often processed by machine, for the purpose of which in most cases they are first singled from a stack and then transported in singled form, i.e. singly, along a transport path. For examining value documents with respect to their state and/or their authenticity and for examining certain aspects of the processing, in particular the transport, ultrasound can be employed for example. Examining the transport within the scope of the present invention is understood to mean ascertaining whether value documents are transported in a single and non-overlapping form and/or how they are aligned during the transport relative to their transport direction and/or whether or at which points in time these pass a specified location of the transport path with a leading edge, regarded in the transport direction, or trailing edge, regarded in the transport direction. In the prior art, for examination there are employed ultrasound sensors which have one or several piezoelectric ultrasonic transducers. For generating ultrasound, the ultrasonic transducers employ a piezoelectric element which is excited to mechanical oscillations by a transmit signal in the form of an electric alternating voltage. For receiving ultrasound, a voltage occurring when pressure is exerted on the piezoelectric element is captured and evaluated.

These piezoelectric ultrasonic transducers, however, must be produced individually and be assembled to a sensor, which is relatively elaborate. In addition, such ultrasonic transducers are relatively slow. Accordingly, the local resolution achievable therewith is not always as good as it is desirable.

The present invention is therefore based on the object of stating a device for examining value documents and/or the transport of value documents by means of ultrasound, which is simple to produce and/or permits a proper examination of value documents. There should further be stated a method for examining value documents and/or the transport of value documents by means of ultrasound, which permits a proper examination of value documents.

The object is achieved by a device having the features of the claim 1 and in particular a device for examining value documents and/or the transport of value documents, which are transported along a specified transport path in a specified transport direction, by means of ultrasound with ultrasound transmitters disposed offset in a direction transverse to the transport direction for emitting, upon transmit signals, ultrasound on the transport path and ultrasound receivers disposed offset in a direction transverse to the transport direction for receiving ultrasound which is generated by means of the ultrasound transmitters and for emitting receive signals or with ultrasound transmitters/receivers disposed offset in a direction transverse to the transport direction for emitting, upon transmit signals, ultrasound on the transport path and for receiving the ultrasound after interaction with at least one of the value documents and for emitting receive signals. The ultrasound transmitters and/or ultrasound receivers here respectively have at least one capacitive, micromechanical ultrasonic transducer, or the ultrasound transmitters/receivers here respectively have at least one capacitive, micromechanical ultrasonic transducer.

The object is therefore further achieved by a method with the features of the claim 19 and in particular a method for examining value documents and/or the transport of value documents by means of ultrasound, in which by means of at least one ultrasound transmitter ultrasound is emitted, upon transmit signals, on a value document transported along a transport path and the ultrasound thereupon emanating from the value document is received by means of at least one ultrasound receiver and receive signals are formed, or by means of at least one ultrasound transmitter/receiver ultrasound is emitted, upon transmit signals, on a value document transported along a transport path and the ultrasound thereupon emanating from the value document is received by means of at least one ultrasound transmitter/receiver and receive signals are formed, the at least one ultrasound transmitter and/or at least one ultrasound receiver or the at least one ultrasound transmitter/receiver having at least one capacitive, micromechanical ultrasonic transducer. The method according to the invention can be carried out in particular by means of a device according to the invention, in the method there being employed as ultrasound transmitters or ultrasound receivers or ultrasound transmitters/receivers the ultrasound transmitters or ultrasound receivers or ultrasound transmitters/receivers of the device.

Capacitive, micromechanical ultrasonic transducers are understood within the framework of the present invention to be ultrasonic transducers which have two, preferably areal, electrodes which form a capacitor. A first one of the electrodes is configured, for example as a conductive layer region, on a substrate or can be formed by a region of the substrate, when the substrate is conductive; the other electrode is configured, for example as a conductive layer region, on a membrane or plate spaced apart from the first electrode or can be formed by this, when the membrane or plate is conductive, so that the electrodes form the capacitor. The membrane or plate is configured such that upon application of a suitable electric voltage between the electrodes a force is exerted between membrane or plate and substrate which entails a movement of at least a part of the membrane or plate, for example a change of shape. If between the electrodes there is applied a suitable time-variable voltage, by which the electrodes attract or repel each other, sound waves can be induced by the movement of at least a part of the membrane caused thereby. Such structures are produced preferably with methods for the production of micromechanical structures.

The device has, according to an alternative, ultrasound transmitters and ultrasound receivers. The ultrasound transmitters and/or the ultrasound receivers respectively have at least one ultrasonic transducer, preferably a capacitive, micromechanical ultrasonic transducer. The ultrasound transmitter transmits upon transmit signals or upon the control by transmit signals, i.e. in response to transmit signals fed to it, ultrasound in the direction of the transport path, the ultrasound receiver receives ultrasound which was or is generated by means of the ultrasound transmitter, where applicable after interaction with a value document, i.e. reflection at or transmission through the value document, and generates respective receive signals. If the respective ultrasound transmitter or respective ultrasound receiver has the at least one capacitive, micromechanical ultrasonic transducer, sending the ultrasound is effected, upon control by transmit signals, by means of the at least one capacitive, micromechanical ultrasonic transducer of the respective ultrasound transmitter or receiving the ultrasound is effected by means of the at least one capacitive, micromechanical ultrasonic transducer of the respective ultrasound receiver.

However, according to another alternative it is possible that the device has ultrasound transmitters/receivers, i.e. elements which serve as an ultrasound transmitter and as an ultrasound receiver. These can respectively have at least one capacitive, micromechanical ultrasonic transducer. This, as an ultrasound transmitter, can first emit, upon a corresponding transmit signal, an ultrasonic pulse, in order to be employed then, after emitting the ultrasonic pulse, as a receiver which receives the ultrasonic pulse returned, i.e. reflected, by the value document and forms and emits at least one corresponding receive signal. Exactly this embodiment is made possible by the fact that capacitive, micromechanical ultrasonic transducers are capable of emitting, preferably by a corresponding control with signals, in particular control signals, pulses of very short duration, i.e. have no long ringing time. This embodiment is characterized by a compact construction and is thus also suitable in particular for being employed in smaller value-document processing apparatuses.

The ultrasound receivers or the ultrasound transmitters/receivers in their function as a receiver receive ultrasound in a frequency range in which the ultrasound transmitters or ultrasound transmitters/receivers as a transmitter transmit ultrasound, and form receive signals, which represent at least one property of the received ultrasound, for example the intensity or amplitude or also frequency.

In the device the ultrasound transmitters and ultrasound receivers can be disposed and configured preferably such that respectively one of the ultrasound transmitters and at least one of the ultrasound receivers form an ultrasound path. Along this ultrasound path, the ultrasound emitted by the respective ultrasound transmitter propagates substantially, i.e. except for scattering or diffraction losses, to the ultrasound receiver. An ultrasound transmitter and an ultrasound receiver which form an ultrasound path, hereinafter are referred to as mutually associated. This alignment or association can enable in particular the capture of locally resolved properties, as will become clear in the following.

Ultrasound transmitters and ultrasound receivers of an ultrasound path can be disposed preferably on opposing sides of the transport path, on the one hand. Value documents are then transported through between the ultrasound transmitters and the ultrasound receivers. Ultrasound transmitter and ultrasound receiver forming an ultrasound path is understood to mean, when ultrasound transmitter and ultrasound receiver are disposed on opposing sides of the transport path, that the ultrasound transmitter emits ultrasound substantially in the direction of the ultrasound receiver and the ultrasound receiver receives ultrasound of the ultrasound transmitter; i.e. the ultrasound path is understood to be the path along which the ultrasound substantially propagates from the ultrasound transmitter to the ultrasound receiver. This can be in particular the straight connecting line between the ultrasound transmitter and the ultrasound receiver. Preferably, both the ultrasound transmitter and the ultrasound receiver, which form an ultrasound path, contain at least one capacitive, micromechanical ultrasonic transducer.

In the device it is possible, on the other hand, that the ultrasound transmitters and ultrasound receivers are disposed and configured such that respectively one of the ultrasound transmitters and at least one of the ultrasound receivers are disposed on the same side of the transport path, so that ultrasound emitted from a respective one of the ultrasound transmitters will be received only after interaction with one of the value documents in the transport path by one of the ultrasound receivers and the ultrasound transmitter and the ultrasound receiver thus form an ultrasound path. In this case, ultrasound path is understood to be the path along which the ultrasound transmitted by the ultrasound transmitter propagates substantially to the value document and after reflection at the same to the ultrasound receiver. Preferably, also then both the ultrasound transmitter and the ultrasound receiver, which form an ultrasound path, contain at least one capacitive, micromechanical ultrasonic transducer.

If the device has ultrasound transmitters/receivers, the ultrasound path extends preferably from the respective ultrasound transmitter/receiver to the value document and back.

Preferably, the device can further have a control and evaluation device which is connected with the ultrasound transmitters and ultrasound receivers via signal connections and forms transmit signals for the emitting of ultrasound by at least one of the ultrasound transmitters and emits these to the latter and receives and processes receive signals of at least one of the ultrasound receivers. If the device contains ultrasound transmitters/receivers, it can have a control and evaluation device which is connected with the ultrasound transmitters/receivers via signal connections and forms transmit signals for the emitting of ultrasound by at least one of the ultrasound transmitters/receivers and emits these to the latter and receives and processes receive signals of the at least one of the ultrasound transmitters/receivers; in particular, the same signal connection can be employed for transmit signals and receive signals. This makes it easier to carry out an examination with local resolution. The control and evaluation device can be employed in the method, when in this method the device of the invention is employed, in particular for generating and emitting the transmit signals and for receiving and for processing the receive signals.

The control and evaluation device serves for, among other things, forming and emitting the transmit signals and for receiving and processing the receive signals. For this purpose, it can preferably have, among other things, at least one microcontroller and/or at least one processor and/or at least one FPGA; preferably, these are then programmed accordingly. If the ultrasound transmitters or ultrasound receivers are configured on a circuit carrier, for example a circuit board, at least some elements of the control and evaluation device can also be disposed thereon.

In principle, the transmit signals can be formed by the control and evaluation device in such a way that the ultrasound transmitters continuously emit ultrasound upon the transmit signals or in response to the transmit signals. In the device it is preferred, however, that the at least one capacitive, micromechanical ultrasonic transducer of at least some of the ultrasound transmitters or ultrasound transmitters/receivers and the control and evaluation device are configured such that the at least one capacitive, micromechanical ultrasonic transducer of the respective ultrasound transmitters or the ultrasound transmitters/receivers emits ultrasonic pulses of a specified frequency and duration in dependence on transmit signals of the control and evaluation device or in response to transmit signals of the control and evaluation device, which pulses are preferably shorter than 100 milliseconds. In the method it is preferred, that the at least one capacitive, micromechanical ultrasonic transducer of at least some of the ultrasound transmitters or ultrasound transmitters/receivers is configured such and transmit signals are formed and emitted such that the at least one capacitive, micromechanical ultrasonic transducer of the respective ultrasound transmitters or ultrasound transmitters/receivers emits ultrasonic pulses of a specified frequency and duration in dependence on the transmit signals or in response to the transmit signals, which pulses are preferably shorter than 100 milliseconds. In the method, the transmit signals can be formed and emitted by a or the control and evaluation device. Particularly preferably, in the device and method, all capacitive, micromechanical ultrasonic transducers and the control and evaluation device can be configured for emitting pulses of ultrasound of specified frequency and duration, which pulses are preferably shorter than 100 milliseconds. Preferably, the frequency is in the region of 20 kHz to 1 GHz, particularly preferably in the region between 40 kHz and 1 MHz. The pulse duration is understood to be preferably the width at half the maximum of the sound intensity as a function of time (FWHM), averaging being performed over respectively a period corresponding to the frequency.

The employment of ultrasonic pulses, i.e. pulses of ultrasound which preferably has the specified frequency, has the advantage that a local resolution of the examination is made possible when the value document is examined with ultrasound during the transport past the device or through the latter. A comparatively high local resolution in the transport direction is made possible by capacitive, micromechanical ultrasonic transducers being not very slow, i.e. reacting fast on changes in the transmit signals, when appropriately configured and with an appropriate transmit signal. Hence, short pulses are relatively simply to generate. There then arises the advantage that a high local resolution can be achieved. Further, the problems caused by undesirable ultrasonic pulses reflected at the value document should be smaller.

To receive such ultrasonic pulses also individually, it is preferred in the device that the at least one capacitive, micromechanical ultrasonic transducer of at least some of the ultrasound receivers or ultrasound transmitters/receivers is respectively configured such that it receives ultrasonic pulses of specified frequency and duration which are preferably shorter than 100 milliseconds and forms corresponding receive signals, and that the control and evaluation device is configured to receive and to process the receive signals. In the method, it is preferred that the at least one capacitive, micromechanical ultrasonic transducer of at least some of the ultrasound receivers or ultrasound transmitters/receivers is respectively configured such that it receives ultrasonic pulses of specified frequency and duration which are preferably shorter than 100 milliseconds and forms corresponding receive signals, and the receive signals are received and processed preferably by means of the control and evaluation device of the device according to the invention. Preferably, these ultrasound transmitters and ultrasound receivers form respectively one ultrasound path. The control and evaluation device can be configured in particular such that it filters the receive signals with respect the frequency, so that the capacitive, micromechanical ultrasonic transducers do not need to be employed for ultrasound having a frequency near a possible mechanical resonance frequency. The frequency is here given by the frequency of the transmit signals for the associated ultrasound transmitter or of the ultrasound emitted by the associated ultrasound transmitter. Further, the filtering can consist in weakening or suppressing signal portions having frequencies beyond a specified narrow band within which the frequency of the transmitted ultrasound lies.

In principle, the capacitive, micromechanical ultrasonic transducers can be configured individually and be held in or at the device. However, in the device it is preferred that at least one of the ultrasound transmitters has at least two capacitive, micromechanical ultrasonic transducers and/or at least two of the ultrasound transmitters respectively have at least one capacitive, micromechanical ultrasonic transducer, and these capacitive, micromechanical ultrasonic transducers are disposed on a chip and respectively have electrodes which are contacted by conductive paths on the respective chip and/or that at least one of the ultrasound receivers has at least two capacitive, micromechanical ultrasonic transducers and/or at least two of the ultrasound receivers respectively have at least one capacitive, micromechanical ultrasonic transducer, and these capacitive, micromechanical ultrasonic transducers are disposed on a chip, respectively have electrodes which are contacted by conductive paths on the respective chip or in which at least one of the ultrasound transmitters/receivers has at least two capacitive, micromechanical ultrasonic transducers and/or at least two of the ultrasound transmitters/receivers respectively have at least one capacitive, micromechanical ultrasonic transducer, and these capacitive, micromechanical ultrasonic transducers are disposed on a chip, and respectively have electrodes which are contacted by conductive paths on the respective chip. This embodiment has the advantage that the capacitive, micromechanical ultrasonic transducers not only are simple to produce and to contact in the same or different sizes in a larger number quite exactly aligned to each other, but also the mounting to an ultrasonic sensor is simple, because the alignment of the transducers to each other is specified by the chip. Preferably, at least 4, more preferably at least 20 capacitive, micromechanical ultrasonic transducers are configured on one single chip.

This embodiment hence offers the advantage that the ultrasonic transducers with small distances to each other are simple to produce. Preferably, in the device, adjacent ones of the capacitive, micromechanical ultrasonic transducers configured on a chip have a distance between 100 μm and 10 mm in the transport direction and/or a distance between 100 μm and 10 mm transverse to the transport direction, if the capacitive, micromechanical ultrasonic transducers have capacitive, micromechanical ultrasonic transducers adjacent in the respective direction. This makes it possible to measure ultrasound properties along tracks on the value document parallel to the transport direction which are very closely adjacent, and thus to obtain these ultrasound properties with a high local resolution transverse to the transport direction of the value document. In particular, gaps thus extending in the transport direction, as they arise in piezoelectric ultrasonic transducers generally further spaced apart from each other, can be kept small or completely avoided upon the capture of ultrasound properties.

The arrangement or configuration on a chip further has the advantage that the ultrasonic transducers are simple to produce in specified forms and in a wide range of extents. In particular it can be preferred in the device that at least one of the capacitive, micromechanical ultrasonic transducers has an extent between 100 μm and 10 mm in the transport direction and/or an extent between 100 μm and 10 mm transverse to the transport direction. Preferably, this applies to all capacitive, micromechanical ultrasonic transducers. Such a region of extents makes it possible to obtain a proper local resolution of the ultrasound properties. The extent is understood here to be the length of the longest straight path which extends in the specified direction and is limited by edge portions of the respective ultrasonic sensor.

The device can also have at least two chips with capacitive, micromechanical ultrasonic transducers, the capacitive, micromechanical ultrasonic transducers of an ultrasound transmitter or ultrasound receiver or ultrasound transmitter/receiver preferably being disposed or configured on only one of the chips.

One difficulty when capturing ultrasound properties in locally resolved manner often is that ultrasound transmitted on an ultrasound path can also be captured directly or indirectly by ultrasound receivers of adjacent ultrasound paths. This leads to undesirable inaccuracies of the measurement on adjacent ultrasound paths. In the device it is thus preferred that the control and evaluation device is configured to emit transmit signals to at least two different, preferably adjacent ones of the ultrasound transmitters or ultrasound transmitters/receivers preferably at the same time, so that these emit ultrasound with different frequency or pulses of ultrasound with different frequency, and to receive and to process receive signals of the ultrasound receiver forming an ultrasound path with the respective ultrasound transmitter or of the ultrasound transmitter/receiver, thus preferably to filter these according to the frequency of the ultrasound emitted by the respective ultrasound transmitter, i.e. in dependence on the position of the ultrasound receiver or the relative position of the ultrasound receivers to each other or the relative position of the ultrasound transmitters to each other. In the method it is preferred that transmit signals are emitted to at least two different, preferably adjacent ones of the ultrasound transmitters or ultrasound transmitters/receivers, so that these emit ultrasound with different frequency or pulses of ultrasound with different frequency, and receive signals of the ultrasound receiver forming an ultrasound path with the respective ultrasound transmitter or of the ultrasound transmitter/receiver, or upon reception of ultrasound generated by the ultrasound transmitter, are received and processed, thus preferably are filtered corresponding to, i.e. in dependence on the position of the ultrasound receiver or the relative position of the ultrasound receivers to each other or the relative position of the ultrasound transmitters to each other. The frequency of the ultrasound can in particular be a function of the position of the ultrasound path along which the ultrasound propagates. Further, the ultrasound transmitters can more preferably be directly adjacent. The capacitive, micromechanical ultrasonic transducers can be configured here preferably in such a way that they are respectively configured for emitting ultrasonic pulses of the ultrasonic frequency corresponding to their position. The filtering of the receive signals of one of the ultrasound receivers can be effected preferably at the frequency at which the associated ultrasound transmitter has emitted ultrasound. This embodiment has the advantage that the ultrasound which was transmitted on an ultrasound path cannot or only weakly be received by the receiver of an adjacent ultrasound path and/or the corresponding disturbing signals can be filtered out. In this way, the local resolution can be increased, because the distance between adjacent ultrasound transmitters or ultrasound receivers, which distance is otherwise necessary because of the danger of disturbance by measurements along adjacent ultrasound paths or crosstalk, can be chosen to be lower. In dependence on the configuration of the capacitive, micromechanical ultrasonic transducers with respect to their transmitting spectrum and also receiving spectrum and, above all, of the control and evaluation device, there can altogether arise a very narrow-band characteristic for an ultrasound path and thus an especially proper suppression or avoidance of disturbances.

According to a further possibility, which where applicable is combinable with the possibility, described in the preceding paragraph, for reducing disturbances upon the measurement at locations adjacent in the direction of the transport direction of the value document, there can be generated at least one sequence of ultrasonic pulses, in which consecutive ultrasonic pulses have a different specified ultrasonic frequency. In the device, preferably the control and evaluation device can be configured to emit transmit signals to at least one of the ultrasound transmitters or of the ultrasound transmitters/receivers in such a way, i.e. to control at least one of the ultrasound transmitters or of the ultrasound transmitters/receivers with transmit signals in such a way that this emits a sequence of ultrasonic pulses from which at least two successive ones have a specified different frequency, and to receive and process receive signals of the ultrasound receiver associated with the respective ultrasound transmitter or of the ultrasound transmitter/receiver, preferably to filter these according to the frequencies or the succession of the frequencies of the emitted pulses. In the method it is preferred that transmit signals are emitted to at least one of the ultrasound transmitters such, i.e. at least one of the ultrasound transmitters is controlled with transmit signals such that this emits a sequence of ultrasonic pulses from which at least two successive ones have a specified different frequency and receive signals of the ultrasound receiver associated with the respective ultrasound transmitter or of the ultrasound transmitter/receiver are received and processed, preferably filtered according to the frequency sequence of the emitted pulses. The ultrasonic pulses of the sequence thus respectively have an ultrasonic frequency according to a specified frequency sequence. This development has the advantage that echoes, i.e. pulses reflected at the value document and not intended for being received, at most have a weak, preferably no, influence on the measurement at locations adjacent in the transport direction. In particular when capacitive, micromechanical ultrasonic transducers are not operated at their resonance frequency, short pulses and thus a high local resolution are simple to generate.

In principle, the ultrasound transmitters and/or ultrasound receivers or ultrasound transmitters/receivers respectively need to have only one capacitive, micromechanical ultrasonic transducer. It is also possible, however, that in the device of the invention or in the method according to the invention preferably at least one of the ultrasound transmitters and/or ultrasound receivers or ultrasound transmitters/receivers has at least two capacitive, micromechanical ultrasonic transducers. These can be configured identically at least in their properties. In the method, transmit signals are emitted to these capacitive, micromechanical ultrasonic transducers preferably such that these emit ultrasound with the same frequency, or the receive signals are evaluated for a specified same frequency. In the device or the method the capacitive, micromechanical ultrasonic transducers of the at least one ultrasound transmitter or ultrasound receiver or ultrasound transmitter/receiver can be connected with the control and evaluation device for example such and the control and evaluation device can be configured such that it emits transmit signals to the ultrasonic transducers, so that these emit ultrasound of the same frequency, or that it processes or evaluates the receive signals for the same frequency, for example filters and processes them.

For example, the ultrasonic transducers can be switched in parallel; the electrodes of the ultrasonic transducers corresponding to each other are then connected with respectively the same ports of the control and evaluation device. The transmit signals then do not necessarily differ, except for maybe their size, from those for ultrasound transmitters or ultrasound transmitters/receivers with only one capacitive, micromechanical ultrasonic transducer. This can be advantageous in particular when capacitive, micromechanical ultrasonic transducers are supposed to emit ultrasound with a frequency or intensity or in a solid angle or are supposed to receive with a frequency or intensity or from a solid angle, for which form and oscillation properties of the ultrasonic transducers are not very favourable.

However, in the device, the at least two ultrasonic transducers can also be connected individually with the control and evaluation device in such a way and this can be configured in such a way that the control and evaluation device can emit transmit signals to these ultrasonic transducers respectively individually. The control and evaluation device is then preferably configured such that to these capacitive, micromechanical ultrasonic transducers it individually emits such transmit signals, that these emit ultrasound with the same specified frequency, i.e. that upon the transmit signals these emit ultrasound with the same frequency, or that it processes or evaluates receive signals of the at least two capacitive, micromechanical ultrasonic transducers, which receive ultrasound of the same frequency, jointly for the same frequency. The transmit signals can then in particular be formed such that the at least two ultrasonic transducers emit the ultrasound substantially in phase or with the same phase. This embodiment can be advantageous, for example, for generating an ultrasound field with higher intensity or larger extent.

In a preferred variant, in the device, the control and evaluation device can be configured such that it emits to the capacitive, micromechanical ultrasonic transducers, which at least partly form an ultrasound transmitter, such transmit signals that these emit ultrasound of the same frequency and different phase, preferably such that the emitted ultrasound of the two transducers is bundled or the direction thereof is changed. In the method of this variant, to the ultrasonic transducers there are emitted preferably such transmit signals that the former emit ultrasound of the same frequency and different phase, preferably such that the emitted ultrasound of the two transducers are bundled or the direction thereof is changed. This allows the directional characteristic of the emitted ultrasound and thus the local resolution of the device to be improved, without the intensity of the ultrasound having to be lowered. In a further variant, the control and evaluation device can further be configured to change the phases in time-dependent fashion such that the main transmit direction of the resultant ultrasound is turned in a specified manner.

The device of the invention and the method according to the invention can be employed in particular in apparatuses for processing value documents. The object of the present invention is hence also an apparatus for processing value documents, with a feeding device for accepting value documents to be processed, an output device for outputting or accepting the processed value documents, a transport device for transporting the value documents from the feeding device along a transport path to the output device and at least one device of the invention, disposed in the region of a portion of the transport path, for examining the value documents and/or the transport of the value documents which are transported along the transport path.

In the device and the method, a processing of the receive signals may already be only the ascertaining of ultrasound transmission or remission values as a function of a location, preferably for at least one specified frequency, on a value document.

In the device, however, the control and evaluation device can also be configured to ascertain from the receive signals at least one value which represents the weight per unit area and/or the thickness of the value document. In the method there can be ascertained preferably from the receive signals, preferably by means of an evaluation device or the control and evaluation device, at least one value which represents the weight per unit area and/or the thickness of the value document. Particularly preferably, in the device the control and evaluation device can be configured to ascertain values from the receive signals which represent the weight per unit area or the thickness in dependence on the location on the value document. In the method there can be ascertained from the receive signals, preferably by means of an evaluation device or the control and evaluation device, values which represent the weight per unit area and/or the thickness in dependence on the location. In this way, there can be examined, for example, the presence of watermarks and, where applicable, the properties thereof and/or the presence of an adhesive strip on a value document. This makes it possible to ascertain properties of the value document which play a role for its authenticity or state.

In the method, processing the receive signals may comprise the further step of ascertaining whether a value document for which receive signals were received was transported as a single value document or at least partly overlapping with another value document, and upon ascertaining at least partly overlapping value documents emitting a signal representing a result of the ascertaining. In the apparatus, the feeding device can preferably have a singler by means of which value documents from a stack of value documents can be singled in an input area and be supplied to the transport device. In the device, for example, the control and evaluation device can then be further configured such that upon the processing of the receive signals it ascertains whether a value document for which receive signals were received was transported as a single value document or at least partly overlapping with another value document and upon ascertaining at least partly overlapping value documents it emits a signal representing a result of the ascertaining. In particular, the transport of a value document can be examined near, preferably immediately after the singler as to whether a single value document is transported. Then the ultrasonic transducers of the device according to the invention are disposed preferably in the region of the transport path near or at the singler. The device of the invention is particularly suited for this, because it demands only little installation space. The event that value documents overlap at least partly after the singling and are supplied in this manner to the transport device is often referred to as a double or multiple pick.

Further, the transport of the value documents can be examined as to whether or when a specified edge, for example, the leading edge of a value document when viewed in the transport direction, passes a specified location and/or whether or how the value document is aligned with specified ones of its edges relative to the transport direction.

Hence, in an advantageous variant of the device, the control and evaluation device can be preferably configured for recognizing upon processing the receive signals using the receive signals whether and/or when at least one specified edge, preferably the leading edge in the transport direction and/or trailing edge in the transport direction, of a value document passes a specified location at the transport path, and/or for recognizing the position thereof and preferably emitting thereupon a corresponding signal, in particular a signal representing the event or the point in time of the event. In the method, upon processing the receive signals, these are then employed for recognizing whether and/or when at least one specified edge, preferably the leading edge in the transport direction and/or the trailing edge in the transport direction, of a value document passes a specified location, and/or for recognizing the position thereof. After the recognition of edges there can be recognized, for example, the arrival of a value document at the device, the value document leaving a capture region of the device, thereby enabling a transport monitoring.

It is also possible, however, to recognize a skew of the value document, i.e. an orientation of the edges of the value document neither parallel nor perpendicular to the transport direction, or the dimensions of a value document.

For this purpose, the ultrasound transmitters or ultrasound transmitters/receivers in the apparatus can be disposed at a specified portion of the transport path. Further, the apparatus can have a machine control device which receives the signal of the device and controls components of the apparatus in dependence on the signal.

The invention will hereinafter be explained further by way of example with reference to the drawings. There are shown:

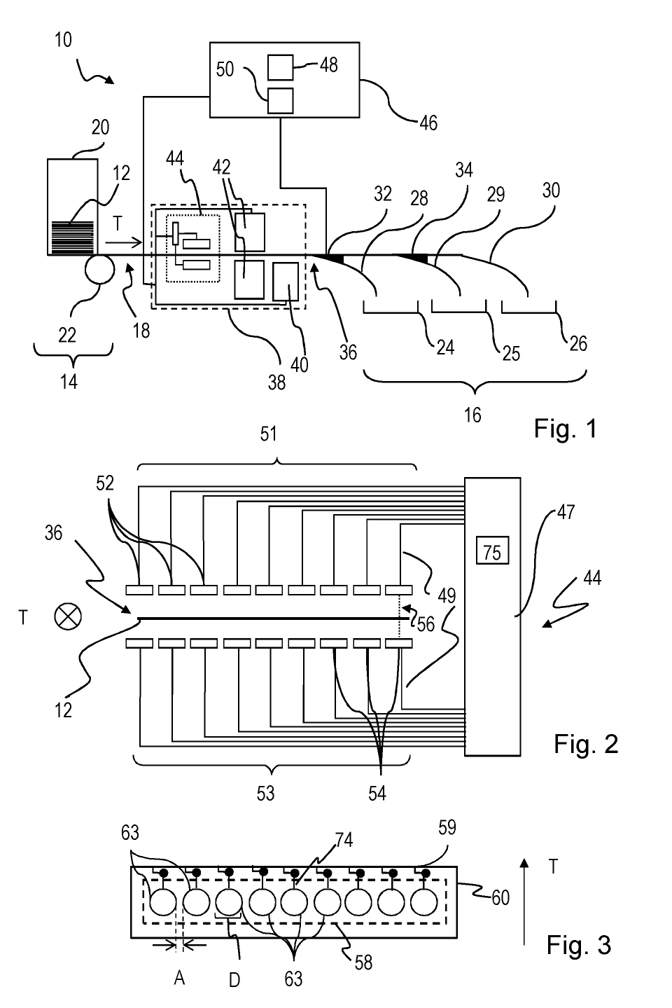

FIG. 1 a schematic view of a value-document processing apparatus, in the example of a bank-note sorting apparatus,

FIG. 2 a schematic representation of an example of a device for examining value documents and/or the transport of value documents by means of ultrasound in the apparatus of FIG. 1,

FIG. 3 a schematic representation of a circuit carrier of the device of FIG. 2 with capacitive, micromechanical ultrasonic transducers formed on a chip, in a plan view,

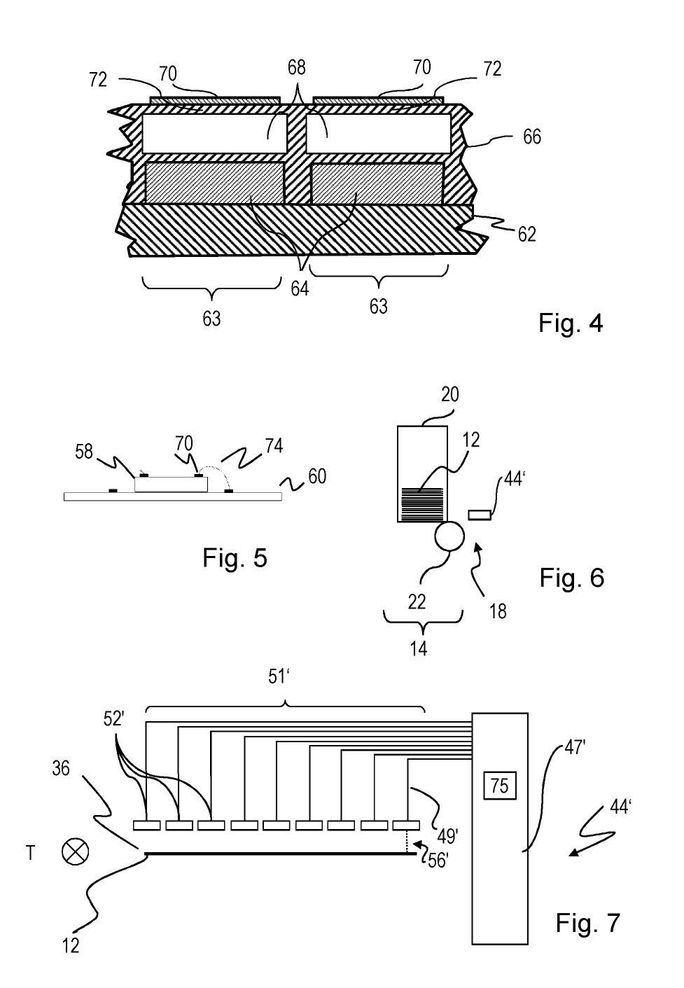

FIG. 4 a schematic sectional view through a section of the chip of FIG. 3,

FIG. 5 a schematic side view of the circuit carrier of FIG. 3 with a contacting between the chip and the circuit carrier,

FIG. 6 a schematic representation of a portion of a second example of a value-document processing apparatus with a feeding device and a second example of a device for examining value documents and/or the transport of value documents,

FIG. 7 a schematic representation of the device for examining value documents and/or the transport of value documents of the apparatus of FIG. 6,

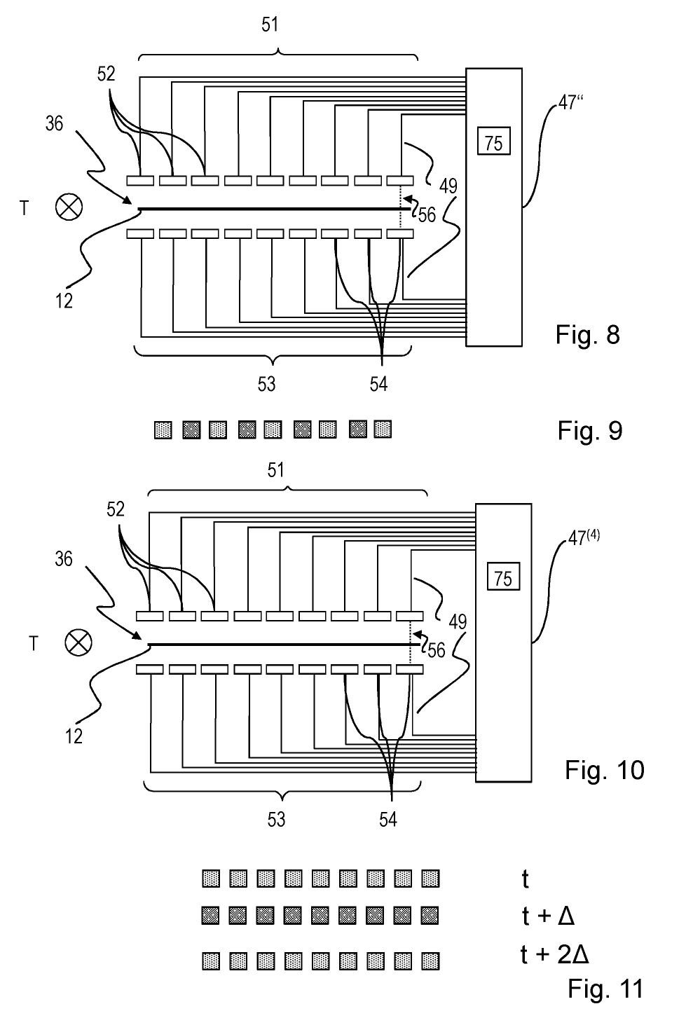

FIG. 8 a schematic representation, corresponding to FIG. 2, of a third example of a device for examining value documents and/or the transport of value documents by means of ultrasound,

FIG. 9 a schematic representation of the ultrasonic frequencies for the ultrasound transmitters and ultrasound receivers, which is employed by the device of FIG. 8,

FIG. 10 a schematic representation, corresponding to FIG. 2, of a fourth example of a device for examining value documents and/or the transport of value documents by means of ultrasound,

FIG. 11 a schematic representation of the ultrasonic frequencies for the ultrasound transmitters and ultrasound receivers, which is employed by the device of FIG. 10,

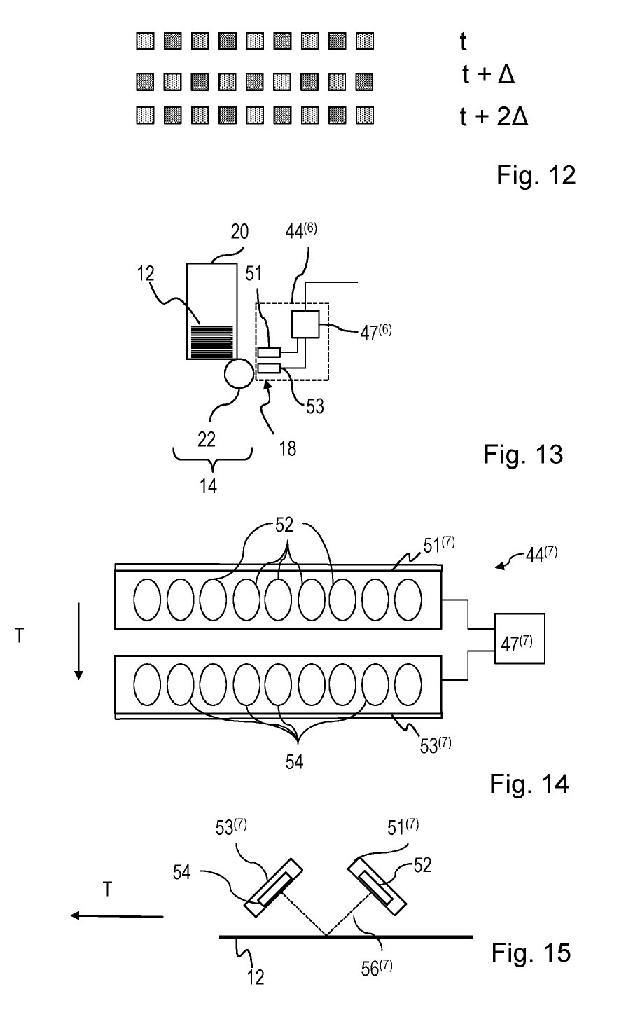

FIG. 12 a schematic representation of the ultrasonic frequencies for the ultrasound transmitters and ultrasound receivers, which is employed by the device of a fifth example,

FIG. 13 a schematic representation of a portion of a sixth example of a value-document processing apparatus with a feeding device and a sixth example of a device for examining value documents and/or the transport of value documents,

FIG. 14 a very schematic view onto a device for examining value documents and/or the transport of value documents of a seventh embodiment example in a direction onto the transport path,

FIG. 15 a very schematic view onto the device of FIG. 14 in a direction transverse to the transport path,

FIG. 16 a very schematic view from above onto a portion of a chip with an ultrasound transmitter which has four parallel-connected capacitive, micromechanical ultrasonic transducers.

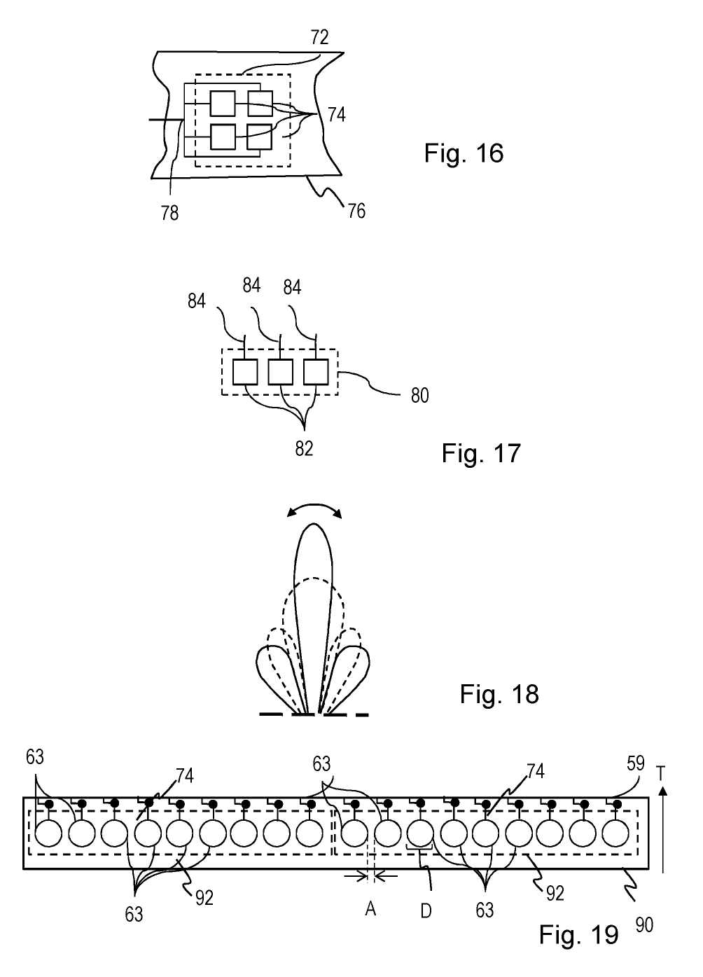

FIG. 17 a very schematic view from above onto a portion of a chip with an ultrasound transmitter which has three capacitive, micromechanical ultrasonic transducers,

FIG. 18 different directional characteristics of the sound field at different phase control of several capacitive, micromechanical ultrasonic transducers of an ultrasound transmitter,

FIG. 19 a schematic representation of a circuit carrier of a further example of a device for examining value documents and/or the transport of value documents with capacitive, micromechanical ultrasonic transducers formed on two chips, in a plan view,

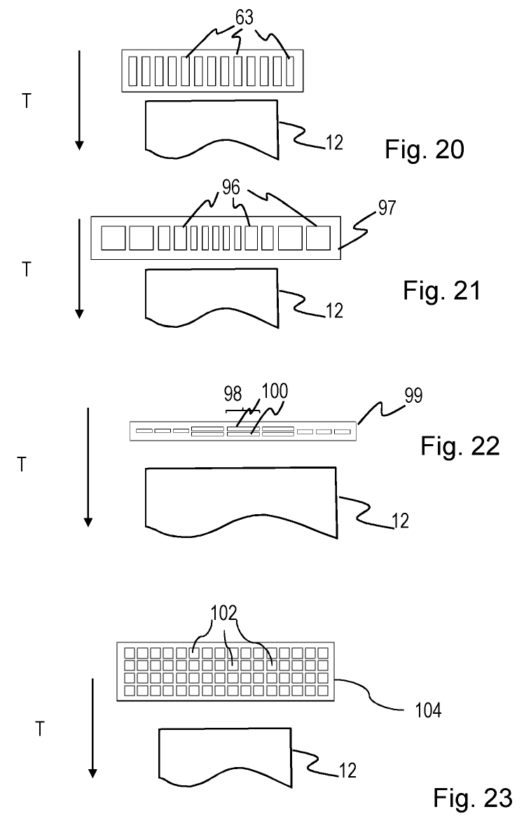

FIG. 20 a schematic representation of a chip with capacitive, micromechanical ultrasonic transducers configured thereon with the same size and at equal distances and formed along a line transverse to the transport direction, in a plan view,

FIG. 21 a schematic representation of a chip with capacitive, micromechanical ultrasonic transducers configured thereon in different sizes and at variable distances and configured along a line transverse to the transport direction, in a plan view,

FIG. 22 a schematic representation of a chip with ultrasound transmitters configured thereon along a line transverse to the transport direction with different numbers of capacitive, micromechanical ultrasonic transducers, in a plan view, and

FIG. 23 a schematic representation of a chip with capacitive, micromechanical ultrasonic transducers configured at the same distances with the same size and configured thereon on a square grid, in a plan view.

A value-document processing apparatus 10 in FIG. 1, in the example an apparatus for processing value documents 12 in the form of bank notes, is configured for sorting value documents in dependence on the state ascertained by means of the value-document processing apparatus 10 and on the authenticity of processed value documents checked by means of the value-document processing apparatus.

It has a feeding device 14 for feeding value documents, an output device 16 for accepting processed, i.e. sorted, value documents, and a transport device 18 for transporting singled value documents from the feeding device 14 to the output device 16.

The feeding device 14 comprises, in the example, an input pocket 20 for a value-document stack and a singler 22 for singling value documents out of the value-document stack in the input pocket 20 and for supplying or feeding them to the transport device 18.

The output device 16 comprises, in the example, three output portions 24, 25 and 26 into which processed value documents can be sorted depending on the result of the processing, in the example a check. In the example, each of the portions comprises a stack pocket and a stacking wheel (not shown) by means of which fed value documents can be deposited in the stack pocket.

The transport device 18 has at least two, in the example three, branches 28, 29 and 30 at whose ends one of the output portions 24 or 25 or 26 is respectively disposed, and, at the branching points, gates 32 and 34 controllable by actuating signals for feeding value documents to the branches 28 to 30 and thus to the output portions 24 to 26 in dependence on actuating signals.

On a transport path 36, defined by the transport device 18, between the feeding device 14, in the example more precisely the singler 22, and the first gate 32 after the singler 22 in the transport direction T there is disposed a sensor device 38 which measures physical properties of the value documents when value documents are being transported past, and forms sensor signals reproducing the measurement results, which represent sensor data. In this example, the sensor device 38 has three sensors, namely an optical remission sensor 40 which captures a remission color image of the value document, an optical transmission sensor 42 which captures a transmission image of the value document, and a device 44 for examining value documents and or the transport of value documents which captures or measures in locally resolved manner ultrasound transmission properties of the value document. While the sensor device 38 outputs the sensor signals of the sensors 40 and 42 without evaluation, the sensor signals of the device 44 are already at least partly evaluated.

A machine control and evaluation device 46 is connected via signal connections to the sensor device 38 and the transport device 18, in particular the gates 32 and 34. In connection with the sensor device 38 it classifies a value document in dependence on the signals of the sensor device 38 for the value document into one of specified sorting classes. These sorting classes can be specified, for example, in dependence on a state value ascertained by means of the sensor data and in dependence on an authenticity value also ascertained by means of the sensor data. As state values, for example, the values “fit for circulation” or “not fit for circulation” can be employed, as authenticity values the values “forged”, “suspect” or “authentic”. In dependence on the ascertained sorting class, it controls by emitting actuating signals the transport device 18, here more precisely the gates 32 or 34, such that the value document is outputted, in accordance with its sorting class ascertained upon the classification into an output portion of the output device 16, said portion being associated with the class. The association with one of the specified sorting classes or the classification is effected here in dependence on criteria specified for the judgement of the state and the judgement of the authenticity, which criteria depend on at least a part of the sensor data.

The machine control and evaluation device 46 has for this purpose in particular, besides corresponding interfaces for the sensor device 38 or its sensors and the device 44, a processor 48 and a memory 50 connected with the processor 48, in which memory at least one computer program with program code is stored upon whose execution the processor 48 controls the apparatus or evaluates the sensor signals of the sensor device 38, in particular for ascertaining a sorting class of a processed value document, and controls the transport device 18 in accordance with the evaluation.

The machine control and evaluation device 46 ascertains from the sensor signals of the sensor device 38 in a sensor-signal evaluation at least one value-document property which is relevant for checking the bank notes for their authenticity and/or state. Preferably, a plurality of said properties are ascertained. In this example, there are ascertained as optical value-document properties a transmission image and a remission image, and as an acoustic property the ultrasound transmission in dependence on the location on the value document.

In dependence on value-document properties, the machine control and evaluation device 46 respectively ascertains for the different sensors sorting signals which represent whether or not the ascertained value-document properties represent an indication of the state or the authenticity of the value document. In consequence of these signals, corresponding data can be stored in the machine control and evaluation device 46, for example the memory 50, for a later use. In dependence on the sorting signals, the machine control and evaluation device 46 then ascertains an overall result for the check according to a specified overall criterion, and forms the sorting or control signal for the transport device 18 in dependence on the result.

For processing value documents 12, value documents 12 inserted into the input pocket 20 as a stack or singly are singled by the singler 22 and fed in singled form to the transport device 18, which transports the singled value documents 12 past the sensor device 38. The latter captures the properties of the value documents 12, whereby sensor signals are formed which represent the properties of the respective value document. The machine control and evaluation device 46 captures the sensor signals, ascertains in dependence thereon a sorting class, in the example a combination of an authenticity class and a state class, of the respective value document, and controls the gates in dependence on the result such that the value documents are transported in accordance with the ascertained sorting class into an output portion associated with the respective sorting class.

For ascertaining a sorting class on the basis of ultrasound properties, there serves the device 44 for examining a value document, which device is employed as a transmission ultrasonic sensor and captures ultrasound transmission data as a function of a location on the value document and in the example is constructed as follows (cf FIGS. 2 and 3).

The device 44 for examining value documents by means of ultrasound has, as very schematically shown in FIG. 2, a transmitter module 51 with a set of ultrasound transmitters 52 and a receiver module 53 with a set of ultrasound receivers 54, which are disposed on opposing sides of the transport path 36 along a line extending transverse to the transport direction. The ultrasound transmitters 52 emit ultrasound upon respective transmit signals, the ultrasound receivers 54 upon receiving ultrasound form receive signals reproducing or describing at least one property of the ultrasound. The number and arrangement of the ultrasound transmitters 52 corresponds here to the number and arrangement of the ultrasound receivers 54. For clarity's sake, only some ultrasound transmitters or ultrasound receivers are shown in the Figures. Actually, there are respectively present so many ultrasound transmitters or receivers that ultrasound transmitters or receivers are disposed transverse to the transport path in a width which is larger than the respective extent of value documents of value document types intended to be processed. Respectively one of the ultrasound transmitters 52 and one of the ultrasound receivers 54 are mutually aligned such that the ultrasound radiated by the respective ultrasound transmitter, in particular after transmission through a value document 12 transported along the transport path 36, is aligned to the respective ultrasound receiver, so that the ultrasound is emitted substantially, i.e. except for, for example, scattering and diffraction effects, in the direction of the ultrasound receiver and the latter can receive the ultrasound. The respective ultrasound transmitter and the respective ultrasound receiver thus form an ultrasound path 56 represented in dotted lines, which in this embodiment example is aligned substantially perpendicular to the transport path and whose endpoints form the ultrasound transmitter and the ultrasound receiver; the ultrasound transmitter and the ultrasound receiver are designated as mutually associated.

For controlling the ultrasound transmitters 52 with transmit signals and for receiving receive signals by the ultrasound receivers 54 and the processing thereof, these are individually connected with a control and evaluation device 47 of the device 44 by means of signal connections 49 shown only very schematically.

With each pair from one of the ultrasonic transmitters and the ultrasonic receiver 54 associated therewith or with each ultrasonic path 56 in connection with the control and evaluation device 47, it is thus possible to ascertain a value for the ultrasound transmission of the value document 12 at the location acoustically irradiated with the ultrasound at a given time.

The ultrasound transmitters 52 and the ultrasound receivers 54 are very schematically shown in FIGS. 3 and 4. Each of the ultrasound transmitters 52 and each of the ultrasound receivers 54 has a capacitive, micromechanical ultrasonic transducer. Here the capacitive, micromechanical ultrasonic transducers of a pair from one ultrasound transmitter 52 and one ultrasound receiver 54, which pair forms an ultrasound path 56, are configured identically. In this embodiment example, all the capacitive, micromechanical ultrasonic transducers are substantially configured identically. The capacitive, micromechanical ultrasonic transducers 63 of the ultrasound transmitters 52 are configured on a chip 58, the same applies to the ultrasonic transducers of the ultrasound receivers 54. The transmitter module has, besides the chip 58, a circuit carrier 60 also serving as a retainer for the chip 58, for example, a circuit board, on which the chip 58 is held and is contacted by conductive paths 59 thereon. The conductive paths 59 lead to the control and evaluation device 47.

Because the chips and the circuit carriers, except for the arrangement of the conductive paths and of electric components, are substantially constructed identically, it is sufficient to describe only the circuit carrier 60 with the chip 58 with the capacitive, micromechanical ultrasonic transducers 63 forming the ultrasound transmitters 52.

The chip 58 has a substrate 62 on which for forming respectively one ultrasonic transducer 63 there is configured a first electrode 64 in the form of a portion of an electrically conductive layer. On this electrode 64 there is configured a further insulating layer 66 having cavities 68. Above each of the cavities 68 there is located on the insulating layer 66 respectively a region with a conductive layer, which region forms the second electrode 70. Hence, the second electrodes 70 are respectively disposed on a thin plate or membrane 72 which extends above the cavity 68. The electrodes 66 and 70 thus form respectively one capacitor. The electrodes together with the membrane 72 form the capacitive, micromechanical ultrasonic transducer 63. The layer 66, in particular the material and thickness thereof are chosen such that the layer can be deformed elastically by forces between the electrodes.

The electrodes 64 and 70 are connected with conductive paths, from which FIG. 3 shows only the conductive paths 59. The conductive paths are connected with the control and evaluation device 47 and form signal connections 49 to this. Upon applying voltage between respectively one pair of electrodes 64 and 70 separated by one of the cavities 68, a force is exerted onto these which leads to a deformation of the membrane 72. Upon applying a voltage with a suitable frequency in the range of the ultrasonic frequency, i.e. with more than 20 kHz, there can be generated a deformation of at least a part of the membrane 72 with the corresponding frequency and ultrasound by the corresponding movement, the transducer acts as a transmitter. Vice versa, a deformation of the membrane 72 caused by the action of ultrasound leads to a corresponding change of the capacitance of the capacitor formed by the electrodes. By a suitable circuit of the ultrasonic transducer, not shown in the Figures, the change of the capacitance can be captured or a suitable current can be generated. This is detectable as a time-variable receive signal by means of the control and evaluation device 47 connected via the signal connections 49.

In this example, the electrodes 70 are connected via wires 74 (cf FIGS. 3 and 5) with the conductive paths 59, only partly shown in FIG. 3, on the circuit carrier 60. This similarly applies to the electrode 64, but the wires are not shown.

The membranes 72 above the cavities 68 and thus substantially the such formed ultrasonic transducers 63 have in the example, transverse to the radiating or receiving direction, a circular form which has an extent D, in the example a diameter, of 2 mm. The capacitive, micromechanical ultrasonic transducers have here a distance A, more exactly a distance of the circumference lines, of 1 mm transverse to the transport direction. These dimensions are intended for capacitive, micromechanical ultrasonic transducers which are to be operated for generating or for receiving ultrasound with 500 kHz.

For forming and emitting the transmit signals and for receiving and for evaluating the receive signals, the control and evaluation device 47 has, besides components on the circuit carriers, a processor or controller 75 which is connected with the signal connections 49. Besides the processor 75, the control and evaluation device 47 has a memory in which instructions for a computer program are stored upon whose execution the processor forms and emits the transmit signals or receives and processes or evaluates the receive signals, as described below.

The control and evaluation device 47, in the example in particular the instructions of the computer program, and the capacitive, micromechanical ultrasonic transducers are configured such that the control and evaluation device 47 controls the ultrasonic transducers of the ultrasound transmitters with transmit signals such or emits such transmit signals to these that the capacitive, micromechanical ultrasonic transducers emit, preferably substantially at the same time, ultrasonic pulses with an ultrasonic frequency of 500 kHz and a duration of 10 μs. The pulses are emitted here with a repetition frequency of 5 kHz. These values are suitable preferably for transport speeds of 5 m/s to 10 m/s.

Further, the control and evaluation device 47 is configured to receive, in agreement with the control of the ultrasound transmitters 52 or the emitting of the transmit signals, receive signals of the ultrasound receivers 54 which these form upon receiving the transmitted ultrasonic pulses or the ultrasonic pulses of the frequency of the transmitted ultrasonic pulses which are formed by the transmitted ultrasonic pulses by interaction with a value document. The control and evaluation device 47 is configured in particular to filter the receive signals according to the frequency of the emitted ultrasound and the pulse duration and to ascertain a property of the received ultrasonic pulses or an ultrasound property of the value document at the location of the ultrasound receiver. The ultrasound property can be, in the example, the ultrasound transmission through the value document. The control and evaluation device 47 is further configured to form and to emit sensor signals which describe locations on the value document and the ultrasound transmission respectively ascertained for these locations.

Upon a transport of a value document 12 along the transport path 36 in between through the ultrasound transmitters 52 and ultrasound receivers 54, the control and evaluation device 47 emits transmit signals to the ultrasound transmitters 52, so that these emit at regular intervals ultrasonic pulses of the mentioned duration and frequency onto the value document 12 and the ultrasound receivers 54 receive the ultrasonic pulses, thereupon emanating (transmitted) from the value document 12, under formation of receive signals. The control and evaluation device 47 captures, according to the transmit signals, the receive signals which reproduce the intensity or power of individual, received ultrasonic pulses as a function of time and thus because of the constant transport speed also of the location on the value document. It thus ascertains for the ultrasound paths between the ultrasound transmitters 52 and ultrasound receivers 54 and thus locations which are hit by the ultrasound on the ultrasound path, ultrasound transmission values which describe the ultrasound transmission at the locations on the respective value document. The locations lie on tracks on the value document along the transport direction. This happens line by line, so that after the value document has passed, locally resolved ultrasound transmission values are present for the whole value document. The transmission values are given here simply by the received ultrasonic pulse energies, assuming a basically constant transmit power of the ultrasonic transmitters 52. In other embodiment examples, however, it is also possible to divide the received ultrasound pulse energies by a specified or measured ultrasound pulse energy of transmitted pulses and to thus obtain normalized transmission values.

Sensor signals which describe the locations and the ultrasound transmission values ascertained for these can then be transferred from the control and evaluation device 47 to the machine control and evaluation device 46 and be further evaluated by this. In another embodiment examples, the evaluation can also be carried out by the control and evaluation device. For example, the limpness of a value document could be ascertained or a check for the presence of an adhesive strip can be carried out, as this is known from the prior art.

A second embodiment example in FIG. 6 and FIG. 7 differs from the first embodiment example, on the one hand, in that a device 44′ for examining value documents and/or the transport of value documents by means of ultrasound is disposed at the transport path 36 near the singler 22. On the other hand, in the sensor device 38 of the first embodiment example the device 44 is replaced by a conventional ultrasonic transmission sensor. Otherwise, for corresponding components the same reference signs are employed and the explanations regarding the first embodiment example apply here accordingly. FIG. 6 hence shows only a corresponding detail of the apparatus in FIG. 1 with, among other things, the feeding device 14, a portion of the transport path 36 and the device 44′. The device 44′ differs from the device 44, on the one hand, in the fact that instead of the transmitter module 51 and of the receiver module 53 or instead of the sets of ultrasound transmitters 52 or ultrasound receivers 54 it has only a transmitter/receiver module 51′ with a set of ultrasound transmitters/receivers 52′ and, accordingly, the control and evaluation device 47 is replaced by a control and evaluation device 47′. As illustrated in FIG. 7, the ultrasound transmitters/receivers 52′ are connected respectively singly via signal connections 49′ with the control and evaluation device 47′. Hence, for each of the ultrasound transmitters/receivers 52′ the transmit signals and the receive signals are led over the same signal connection.

The transmitter/receiver module 51′ is configured substantially as the transmitter module 51 of the first embodiment example, so that the explanations of the first embodiment example apply here accordingly. In particular, the ultrasound transmitters/receivers 52′ respectively have a capacitive, micromechanical ultrasonic transducer and are configured in a chip.

The chip is likewise held and contacted on a circuit carrier, so that the ultrasound transmitters/receivers emit ultrasound substantially in a perpendicular direction onto the value document and receive ultrasound returned by the value document from a direction perpendicular to the transport plane of the value document. By respectively one of the ultrasound transmitters/receivers there is hence formed an ultrasound path 56′ which extends in the example substantially perpendicular to a plane of the value document. However, the conductive paths and, where applicable, other electric components or circuits on the circuit carrier are changed such that the capacitive, micromechanical ultrasonic transducers can act as a transmitter and receiver of ultrasound.

The control and evaluation device 47′ is configured such that it emits transmit signals to the ultrasound transmitters/receivers 52′, upon which the ultrasound transmitters/receivers emit ultrasonic pulses as in the first embodiment example, the pulse duration being not longer, however, than the transit time of an ultrasonic pulse from the ultrasound transmitter/receiver to the value document, preferably no longer than between 10 μs and 10 ms.

As recognizable in FIG. 6 and FIG. 7, this device is characterized by the fact that it is especially compact and demands only very little space.

The device or the sensor 44′ is configured to recognize by means of ultrasound whether a front or leading edge, in the transport direction, of a value document crosses the ultrasound transmitter/receiver arrangement or the transmitter/receiver module 51′, i.e. at least one of the ultrasound paths.

For this purpose, the control and evaluation device 47′ is further configured to receive the receive signals and to check whether or not their level lies below a specified threshold value which is characteristic for the fact that no ultrasound was reflected at a value document, and in dependence on the result of the check to emit a signal to the machine control and evaluation device 46. The control and evaluation device 47′ checks more precisely whether after a pulse whose level lies below the threshold value there follows a pulse whose level lies above the threshold value. In this case it emits to the machine control and evaluation device 46 a signal which indicates that a value document passes the device. This can use the signal for monitoring the transport.

Alternatively or additionally, the device or the sensor 44, in particular the control and evaluation device thereof, can be configured to recognize by means of ultrasound whether a in the transport direction trailing edge of a value document crosses the ultrasound transmitter/receiver arrangement, i.e. one of the ultrasound paths. When this event is recognized, the control and evaluation device can emit a corresponding signal.

A third embodiment example differs from the first embodiment example in the control of the ultrasound transmitters 52 and the evaluation of the receive signals of the ultrasound receivers 54, for which reason the device 44 is replaced by a device 44″. This differs from the device 44 merely in that the control and evaluation device 47 is replaced by a control and evaluation device 47″ (cf FIG. 8). Further, the ultrasonic transducers are adapted to the different frequencies described in the following. In particular, in this embodiment example at least two different, preferably adjacent, ultrasound transmitters 52 are controlled for emitting ultrasound with different frequency, in this example pulses of ultrasound with different frequency, and receive signals of the ultrasound receiver associated with the respective ultrasound transmitter 52 or forming an ultrasound path 54 with this are received. The receive signals are then processed, in particular filtered in dependence on the position of the ultrasound receivers or the relative position of the ultrasound receivers with respect to the ultrasound transmitters.

The ultrasound transmitters are divided into two groups. The first group comprises, when viewed in the direction of the line of ultrasound transmitters, the first and the respectively next but one ultrasound transmitter, the second one the ultrasound transmitters in between. The ultrasound transmitters are hence respectively associated only with one of the two groups.

The control and evaluation device 47″ is configured such, on the one hand, that it emits transmit signals to the ultrasound transmitters of the first group, so that these emit ultrasonic pulses with a specified pulse length and with a first specified ultrasonic frequency; to the ultrasound transmitters of the second group it emits transmit signals, so that these emit ultrasonic pulses with the specified pulse length and with a second specified ultrasonic frequency.

Corresponding to the division of the ultrasound transmitters in two groups, also the ultrasound receivers are divided in two groups. The first group contains the ultrasound receivers which are respectively associated with one of the ultrasound transmitters of the first group, the second group the ultrasound receivers which are respectively associated with one of the ultrasound transmitters of the second group. The control and evaluation device 47″ is configured to process, in particular to filter, the receive signals of the ultrasound receivers of the first group according to the first ultrasonic frequency, and to process, in particular to filter, the receive signals of the ultrasound receivers of the second group according to the second ultrasonic frequency.

More precisely, the control and evaluation device 47″ is configured as the control and evaluation device 47, but differs therefrom in two regards.

On the one hand, the control and evaluation device 47″ is configured to control, by emitting corresponding transmit signals, respectively nearest adjacent ultrasound transmitters to emit pulses of ultrasound with different frequency.

This is illustrated in FIG. 9., in which there is shown, symbolized by squares, the position of the ultrasound paths 56 or the ultrasound transmitters 52 and ultrasound receivers 54 respectively limiting them in planes parallel to the transport plane or to a transported value document. The ultrasound paths or the ultrasound transmitters 52 and ultrasound receivers 54 respectively limiting them are disposed along a line transverse to the transport direction T. The squares are patterned according to the frequency of the ultrasound which the ultrasound transmitters 52 emit or which the ultrasound receivers 54 respectively associated therewith receive. In the example, the brighter squares with the thinner dotting illustrate a first frequency of 400 kHz and the darker squares with the thicker dotting a second frequency of 600 kHz.

The control and evaluation device 47″ is hence configured such that it emits transmit signals upon whose reception the ultrasound transmitters along the line alternately emit ultrasonic pulses of the first or second frequency, so that between two ultrasound transmitters which emit ultrasound of the first frequency there is disposed an ultrasound transmitter which emits ultrasound of the second frequency.

The ultrasound respectively emitted by one of the ultrasound transmitters is received, here where applicable after transmission through a value document, by the associated ultrasound receiver. This forms a receive signal which is emitted to the control and evaluation device 47″.

The control and evaluation device 47″ is hence configured, on the other hand, to receive and to process receive signals of the ultrasound receiver associated to a respective ultrasound transmitter, in particular to filter in dependence on the properties of the ultrasound emitted by the associated ultrasound transmitter, i.e. here also on the position of the ultrasound receivers or the relative position of the ultrasound receivers with respect to the ultrasound transmitters.

The first and the second ultrasonic frequency are chosen such, on the one hand, that the employed ultrasound properties of a value document do not strongly depend on which one of the two frequencies they are recognized. On the other hand, they are chosen such that the control and evaluation device 47″ can filter out in the receive signals possibly occurring portions of adjacent ultrasound paths by frequency-dependent filtering and suppress them for the further processing.

This avoids a crosstalk between directly adjacent ultrasonic transducers, although the ultrasonic pulses are emitted substantially at the same time.

After the filtering, the signals can be processed as in the first embodiment example.

A fourth embodiment example differs from the first embodiment example by the fact that now the ultrasound transmitters are controlled with transmit signals such that these emit respectively a sequence of ultrasonic pulses from which at least two successive ones have a different frequency. Receive signals of the ultrasound receiver associated with the respective ultrasound transmitter are received and processed, in particular filtered according to the frequency sequence of the emitted ultrasonic pulses. Compared with the first embodiment example, hence only the device 44 is replaced by a device 44⁽⁴⁾ (cf FIG. 10). This differs from the device 44 only in that the control and evaluation device 47 is replaced by a control and evaluation device 47⁽⁴⁾ and the capacitive, micromechanical ultrasonic transducers are adapted to the employed ultrasonic frequencies. Otherwise, the explanations regarding the first embodiment example apply accordingly here.

The first and the second ultrasonic frequencies differ at least in such a way that the employed ultrasound receivers in connection with the control and evaluation device which processes or evaluates the receive signals thereof can unambiguously separate pulses with this frequency, here by filtering with respect to the frequency. The closer the employed ultrasonic frequency are next to each other, the longer pulse durations must be employed to still make possible a separation.

The control and evaluation device 47⁽⁴⁾ is configured, on the one hand, to form transmit signals for each of the ultrasound transmitters 52 and to emit these to the respective ultrasound transmitter, so that this emits a sequence of ultrasonic pulses, in which immediately successive different specified ultrasonic frequencies respectively have here a different one of the two ultrasonic frequencies. In doing so, the ultrasound transmitters are controlled by the control and evaluation device 47⁽⁴⁾ such that they emit pulses respectively substantially at the same time, i.e. with a time delay of less than half a pulse duration between the ultrasound transmitters. For example, this can be such that at first transmit signals for a pulse with the first ultrasonic frequency are emitted to the ultrasound transmitters, then respective transmit signals for the next pulse with the second ultrasonic frequency; this sequence is then repeated several times, where applicable. The frequency of the ultrasonic pulses of the sequence hence alternates with the order in the sequence.

The control and evaluation device 47⁽⁴⁾ is configured, on the other hand, to receive the receive signals of the ultrasound transmitters, in agreement with the transmit signals, and to process, in particular to filter, these according to the transmitted ultrasonic frequency.

This is illustrated in FIG. 11, which illustrates schematically for three immediately successive pulses, which are emitted with a time interval Δ, of a pulse sequence at times t, t+Δ, t+2Δ, ultrasound of which frequency is employed.

The representation corresponds to the one in FIG. 9. Squares symbolize the position of the ultrasound paths 56 or the ultrasound transmitters 52 and ultrasound receivers 54 respectively limiting them in planes parallel to the transport plane or to a transported value document. The ultrasound paths or the ultrasound transmitters 52 and ultrasound receivers 54 respectively limiting them are disposed along a line transverse to the transport direction T. The squares are patterned according to the frequency of the ultrasound which the ultrasound transmitters 52 emit or which the ultrasound receivers 54 respectively associated therewith receive. In the example, the brighter squares with the thinner dotting illustrate a first frequency of 400 kHz and the darker squares with the thicker dotting a second frequency of 600 kHz. Successive lines in FIG. 9 represent the situation at successive points in time. The points in time are spaced apart by the period Δ which corresponds to the frequency 1/Δ with which ultrasonic pulses are emitted, in the example 5 kHz.

The control and evaluation device 47⁽⁴⁾ first emits transmit signals to the ultrasound transmitters which emit substantially ultrasonic pulses of the first frequency, which, where applicable, after interaction with a value document, here transmission through the value document, is received by the ultrasound receivers. The ultrasound receivers 54 form respective receive signals, which they emit to the control and evaluation device 47⁽⁴⁾. The latter filters the receive signals according to the ultrasonic frequency of the ultrasonic pulses and generates ultrasound transmission data. The control and evaluation device 47⁽⁴⁾ then emits transmit signals to the ultrasound transmitters which emit substantially ultrasonic pulses of the second frequency, which, where applicable, after interaction with the value document, here transmission through the value document, is received by the ultrasound receivers. The ultrasound receivers form respective receive signals, which they emit to the control and evaluation device 47⁽⁴⁾. The latter filters the receive signals according to the ultrasonic frequency of the ultrasonic pulses and again generates ultrasound transmission data. These steps are repeated, so that for a value document transported at a known speed ultrasound transmission data as a function of location are ascertained. These can then be further processed as in the first embodiment example.

In this manner, undesirable reflections of ultrasonic pulses which overlap in time with following ultrasonic pulses can be properly separated from the desired ultrasonic pulses. In particular, disturbances by measurements at locations immediately adjacent in the transport direction can thus be diminished.

In a variant of this embodiment example, the connections from the control and evaluation device 47⁽⁴⁾ to the ultrasound transmitters 52 can be replaced by a joint connection which coming from the control and evaluation device 47⁽⁴⁾ branches to the ultrasound transmitters 52.

A fifth embodiment example differs from the third embodiment example by the fact that the ultrasound transmitters are controlled with transmit signals such that they emit ultrasound in a manner and it is evaluated after reception in a manner that combines in a certain manner the third and fourth embodiment example.

Compared with the third embodiment example, hence only the device 44″ is replaced by a device 44⁽⁵⁾ (cf FIG. 10). This differs from the device 44″ only in that the control and evaluation device 47″ is replaced by a control and evaluation device 47⁽⁵⁾ and the capacitive, micromechanical ultrasonic transducers are adapted to the employed ultrasonic frequencies. Otherwise, the explanations regarding the first embodiment example apply accordingly here.

Each of the ultrasound transmitters again emits a sequence of ultrasonic pulses, in which the ultrasonic frequencies of successive ultrasonic pulses differ; in particular they can have a first and a second ultrasonic frequency. However, the sequences for immediately adjacent ultrasound transmitters differ insofar as ultrasonic pulses emitted by these substantially at the same time respectively have a different ultrasonic frequency.

This is illustrated in FIG. 12 which, except for the sequence, corresponds to the ultrasonic frequencies of FIG. 11.

For each point in time at which pulses should be emitted the control and evaluation device emits transmit signals to the ultrasound transmitters such that a first group of the ultrasound transmitters emits respectively one ultrasonic pulse of a first specified ultrasonic frequency, and a second group of the ultrasound transmitters emits ultrasonic pulses of a second specified ultrasonic frequency; for the choice of the two ultrasonic frequencies there apply preferably the same criteria as in the two preceding embodiment examples. In particular, they are chosen as in the two preceding embodiment examples. The groups are chosen as in the third embodiment example such that between two ultrasound transmitters of one of the groups there is a respective ultrasound transmitter of the other group. There thus arises for example at the time t a scheme which corresponds to that of FIG. 10. Upon receiving the ultrasound, the ultrasound receivers respectively form receive signals which are separately fed to the control and evaluation device 47⁽⁵⁾. The latter evaluates the receive signals in dependence on the position of the ultrasound transmitters and of the ultrasound receivers associated therewith, and filters the receive signals according to the frequency of the transmitted ultrasound for the respective ultrasound path or the ultrasound transmitter or of the ultrasound respectively transmitted.

For the next pulse of the sequence at the time t+Δ, the control and evaluation device 47⁽⁵⁾ emits transmit signals to the ultrasound transmitters such that the first group of ultrasound transmitters respectively emits an ultrasonic pulse of the second specified ultrasonic frequency and the second group of ultrasound transmitters ultrasonic pulses of the first specified ultrasonic frequency. The resulting pattern is shown in FIG. 12 in the second line; it corresponds to the pattern at the time t, wherein, however, respectively the first and second frequency are exchanged. This evaluates the receive signals in dependence on the position of the ultrasound transmitters and of the ultrasound receivers associated therewith, and filters the receive signals according to the frequency of the transmit signals for the respective ultrasound path or the ultrasound transmitter or of the ultrasound respectively transmitted.

For the following pulse of the sequence at the time t+2Δ, the control and evaluation device 47⁽⁵⁾ emits transmit signals which correspond to those at the time t and processes the receive signals accordingly.

In these steps, the respective receive signals of the ultrasound receivers are processed according to the frequencies of the ultrasonic pulses emitted by the associated ultrasound transmitters and ultrasound transmission data as a function of the location are output to the machine control and evaluation device.

This procedure has the advantage that upon evaluation of a receive signal for an ultrasound path, possible disturbing influences by ultrasound on directly adjacent ultrasound paths and disturbing influences by ultrasound of pulses for adjacent ultrasound paths can at least partly be filtered out for the preceding pulse. This variant will become realistically applicable by the employment of capacitive, micromechanical ultrasonic transducers, because these enable short pulses, a widely applicable frequency range and a high local resolution transverse to the line.

In a sixth embodiment example in FIG. 13, the transport of value documents is examined immediately after the singler for the presence of overlapping value documents. The apparatus differs from that of the first embodiment example, on the one hand, in that a device 44⁽⁶⁾ for examining the transport of value documents by means of ultrasound is disposed at the transport path 36 near the singler 22. On the other hand, in the sensor device 38 the device 44 is replaced by a conventional ultrasonic transmission sensor. Otherwise, for corresponding components the same reference signs are employed and the explanations regarding the first embodiment example apply here accordingly. FIG. 13 hence shows only a corresponding detail of the changed apparatus of FIG. 1.

The device 47⁽⁶⁾ differs from the device 47 in that the control and evaluation device 47 is replaced by a control and evaluation device 47⁽⁶⁾. The control and evaluation device 47⁽⁶⁾ differs from the control and evaluation device 47 of the first embodiment example only in that it is configured to process the receive signals in a different way. Otherwise, it is configured as the control and evaluation device of the first embodiment example.

More precisely, the control and evaluation device 47⁽⁶⁾ is configured to examine the receive signals for ultrasonic pulses substantially received at the same time by the ultrasound receivers as to whether the level or the intensity of the receive signal is lower than a specified threshold value which is characteristic for the fact that receive signals for a single value document have a value above the threshold value, but those for overlapping value documents have levels below the threshold value. If the control and evaluation device 47⁽⁶⁾ ascertains for a specified number of ultrasound receivers that the threshold value is undershot, it outputs to the machine control and evaluation device 46 a corresponding signal, which indicates that at least two at least partly overlapping value documents are transported.

Upon receiving such a signal, the machine control and evaluation device can then control the transport device in such a way that the overlapping value documents are transported in one of the output pockets specified for this. In another embodiment examples, the transport device can also be configured such that the transport path has a branching point before the sensor device 38, at which there is disposed a gate controllable by actuating signals. At the end of the branch not leading to the sensor device 38 there can then be disposed a pocket for value documents not to be processed. The machine control and evaluation device can then be configured to emit, upon receiving a signal of the device 47⁽⁵⁾, an actuating signal to the gate, so that the overlapping value documents are transported into the pocket and are deposited there.

A seventh embodiment example differs from the first embodiment example only in that the device 44 is replaced by a device 44⁽⁷⁾ for examining value documents and/or the transport of value documents. This differs from the device 44 in two regards. On the one hand, the transmitter module 51⁽⁷⁾ and the receiver module 53⁽⁷⁾, which otherwise are configured as in the first embodiment example, and thus the ultrasound transmitters and ultrasound receivers are disposed on the same side of the transport path 36, in the example above the transport path; so that an examination of the ultrasonic remission as a value-document property can be effected. On the other hand, the control and evaluation device 47⁽⁷⁾ differs from the control and evaluation device 47 only in the fact that it is configured such that the receive signals of the ultrasound receivers are processed in such a way that an ultrasonic remission as a function of a location on a value document is ascertained.

The arrangement of the transmitter module 51⁽⁷⁾ and the receiver module 53⁽⁷⁾ and thus of the ultrasound transmitters 52 and ultrasound receivers 54 or ultrasonic transducers is illustrated in FIG. 14 and FIG. 15; FIG. 14 shows a very schematic view onto the device in a direction onto the transport path, FIG. 15 a section through the device in a direction transverse to the transport path. The signal connections 49⁽⁷⁾ are represented in particular in combined fashion, although, as in the first embodiment example, respectively single signal connections connect the transmitters or receivers with the control and evaluation device.

The transmitter module 51⁽⁷⁾ and the receiver module 53⁽⁷⁾ are configured as in the first embodiment example. The ultrasound transmitters 52 or their ultrasonic transducers are aligned relative to the transport path 36 such that the ultrasound is respectively inclined towards the plane of the transport path or of a value document transported there, and it does not have an essential component in a direction transverse to the transport direction. The ultrasound receivers 54 or their ultrasonic transducers are so disposed and aligned that they receive the ultrasound of the ultrasound transmitters 52 which was reflected at a value document, i.e. are aligned with their receiving direction to the propagation direction thereof. Respectively one ultrasound transmitter and the associated ultrasound receiver form such an ultrasound path 56⁽⁷⁾, which is symbolized by a dashed line in FIG. 15.

In other embodiment examples, the ultrasound transmitters and/or the ultrasound receivers can respectively have at least two capacitive, micromechanical ultrasonic transducers. In this case, the ultrasonic transducers of respectively one ultrasound transmitter or ultrasound receiver are configured on the same chip. These ultrasonic transducers can be connected with the control and evaluation device 47 such that they are controlled with the same transmit signals, i.e. the control and evaluation device emits respectively only one transmit signal which is fed to the two ultrasonic transducers via the output or the same signal connection. Likewise, receive signals of the ultrasonic transducers of respectively one ultrasound receiver can be superimposed, which are fed to the control and evaluation device and are received and processed by this as a receive signal.

The control and evaluation device is configured to form transmit signals for respectively only one ultrasound transmitter and to emit these to it, or to receive the superimposed receive signals from respectively only one ultrasound receiver and to process or evaluate these.

An example of an ultrasound transmitter 72 which has four capacitive, micromechanical ultrasonic transducers 74 is very schematically shown in FIG. 16. The four capacitive, micromechanical ultrasonic transducers 74 of the ultrasound transmitter illustrated by dotted lines are configured identically on the same chip 76 which is shown only partially, and are configured, except for their rectangular form or the rectangular form of the membrane on which the second electrode is configured, as the capacitive, micromechanical ultrasonic transducers of the first embodiment example. The first electrodes together are contacted by a conductive path (not shown), the same applies to the second electrodes which are connected with branches of the conductive path 78. The control and evaluation device is configured to emit transmit signals which correspond to those of the first embodiment example, where applicable except for their level. By the enlarged oscillating area of the four membranes now swinging in phase there can be obtained a broader sound field and a higher sound intensity for an ultrasound transmitter.

In another embodiment example, the ultrasonic transducers for respectively one ultrasound transmitter or ultrasound receiver or ultrasound transmitter/receiver are connected with the control and evaluation device separately via signal connections. The ultrasonic transducers of an ultrasound transmitter can then be controlled in such a way that these emit ultrasound with the same frequency. In this embodiment example, however, the transmit signals differ in their phase.

This embodiment example differs from the first embodiment example by the configuration of the ultrasound transmitters and that of the control and evaluation device. All the other explanations regarding the first embodiment example apply here accordingly. FIG. 17 illustrates an ultrasound transmitter indicated by dashed lines. The ultrasound transmitter 80 which replaces an ultrasound transmitter 52 in the first embodiment example has three identically configured capacitive, micromechanical ultrasonic transducers 82 which are disposed in a line and are disposed on the same chip (not shown). The ultrasonic transducers 82 are configured as in the first embodiment example and are separately connected with separate conductive paths 84 which in turn are connected individually via separate signal connections with the control and evaluation device.

The control and evaluation device differs from that of the first embodiment example only in the fact that for the ultrasonic transducers 82 of each of the ultrasound transmitters 80 it emits separated transmit signals to the ultrasonic transducers 82, so that the ultrasonic transducers generate ultrasonic pulses with equal frequency but different phase. The phases or phase differences are chosen such that by the superimposition of the ultrasound of the ultrasonic transducers 82 of the ultrasound transmitter the resultant sound field is stronger concentrated or focused. This is illustrated in FIG. 18. Therein, the sound field or the directional characteristic of the ultrasonic transducers of the ultrasound transmitter 80 symbolized by a dashed straight line upon control in phase is shown by dashed lines. The respective sound field or the respective directional characteristic upon control with different phases is represented very schematically by continuous lines. The control and evaluation device emits transmit signals in such a way that the ultrasonic transducers emit ultrasonic pulses with different phase, so that there results a better directed directional characteristic or a stronger directed or concentrated sound field.

Preferably, the control and evaluation device can be configured to form and emit the transmit signals such that the phases vary in time. For example, the transmit signals can be formed and emitted such that the directional characteristic as a function of time can be turned by a specified angle, which is indicated in FIG. 18 by a double arrow.

In other embodiment examples, the ultrasound transmitters and/or ultrasound receivers or their capacitive, micromechanical ultrasonic transducers can also be configured on at least two chips, the chips being held and contacted on a circuit carrier such that the ultrasonic transducers are disposed along a line which extends transverse to the transport direction T. This is illustrated in FIG. 19 for the case of a transmitter module in which there are disposed on a circuit carrier 90 of the module two equally configured chips 92 with capacitive, micromechanical ultrasonic transducers and contacted by conductive paths as in the first embodiment example. The chips 92 are configured as the chip in the first embodiment example, the explanations thereon and the reference signs are also employed here. The contacting and connection with the control and evaluation device is effected here in such a way that the capacitive, micromechanical ultrasonic transducers of respectively one ultrasound transmitter or one ultrasound receiver are configured or disposed on the same chip.

Other embodiment examples differ from the first embodiment example in form and distribution of the ultrasound transmitters and ultrasound receivers, which in turn are respectively formed by a capacitive, micromechanical ultrasonic transducer.

FIG. 20 shows an example, in which the ultrasonic transducers 63 are disposed on a transmitter module uniformly with a small distance and hence uniformly high resolution along a line which is longer than the extent of a value document 12 transverse to the transport direction T.

In contrast, FIG. 21 shows an example of a device in which the ultrasonic transducers 96 of a transmitter module 97 are configured in a variable distance and with variable extent. The ultrasonic transducers again are disposed in a line which is longer than the extent of a value document 12 transverse to the transport direction T. The ultrasonic transducers in the center of the line are disposed with a smaller distance to each other, and thus permit an accordingly high local resolution of the measurement. The external ultrasonic transducers are disposed in a larger distance from each other and have a larger sound-generating area. Hence, the local resolution is lower at the edge, but the sound level is higher.

FIG. 22 shows an example, in which the ultrasound transmitters of a transmitter module 99 again are disposed along a line transverse to the transport direction T. The ultrasound transmitters 98 in the center respectively have two capacitive ultrasonic transducers 100 configured side by side in the transport direction, which are contacted in such a way that they can be controlled individually with phase-shifted transmit signals of the same frequency in order to obtain in this way the described focusing in the transport direction.

FIG. 23 shows an example, in which a device for examining value documents and/or the transport of value documents by means of ultrasound has a plurality of capacitive, micromechanical ultrasonic transducers 102 which are configured on a chip 104, in a two-dimensional arrangement, in the example on the intersections of a square grid has. Such a configuration is obtainable at favourable costs only when the ultrasonic transducers on a chip are produced with methods known from micromechanics. The ultrasonic transducers can be controlled individually as single transmitters or receivers or in small groups combined as a transmitter or receiver. In the latter case, in particular a phase-shifted control of the ultrasonic transducers of respectively one transmitter is possible.

In other embodiment examples, the chips can also be configured as SMT elements.

1.-28. (canceled)

29. A device for examining value documents and/or the transport of value documents which are transported along a specified transport path in a specified transport direction, by means of ultrasound with
ultrasound transmitters disposed offset in a direction transverse to the transport direction for emitting, upon transmit signals, ultrasound on the transport path and ultrasound receivers disposed offset in a direction transverse to the transport direction for receiving ultrasound which is generated by means of the ultrasound transmitters and for emitting receive signals or
with ultrasound transmitters/receivers disposed offset in a direction transverse to the transport direction for emitting ultrasound on the transport path upon transmit signals and for receiving the ultrasound after interaction with at least one of the value documents and for emitting receive signals,
wherein the ultrasound transmitters and/or ultrasound receivers respectively have at least one capacitive, micromechanical ultrasonic transducer, or wherein the ultrasound transmitters/receivers respectively have at least one capacitive, micromechanical ultrasonic transducer.

30. The device according to claim 29, in which the ultrasound transmitters and ultrasound receivers are disposed and configured such that respectively one of the ultrasound transmitters and at least one of the ultrasound receivers form an ultrasound path and are disposed on opposing sides of the transport path.

31. The device according to claim 29, in which the ultrasound transmitters and ultrasound receivers are disposed and configured such that respectively one of the ultrasound transmitters and at least one of the ultrasound receivers are disposed on the same side of the transport path, so that ultrasound emitted by a respective one of the ultrasonic transducers will be received, after interaction with one of the value documents in the transport path, by one of the ultrasound receivers and the ultrasound transmitter and the ultrasound receiver form an ultrasound path.

32. The device according to claim 29, which further has a control and evaluation device which is connected with the ultrasound transmitters and ultrasound receivers, and forms and emits transmit signals for the emitting of ultrasound by at least one of the ultrasound transmitters and receivers and processes receive signals of at least one of the ultrasound receivers or
which further has a control and evaluation device which is connected with the ultrasound transmitters/receivers and forms transmit signals for the emitting of ultrasound by at least one of the ultrasound transmitters/receivers and emits these to the latter and receives and processes receive signals of the at least one of the ultrasound transmitters/receivers.

33. The device according to claim 32, in which the at least one capacitive, micromechanical ultrasonic transducer of at least some of the ultrasound transmitters or ultrasound transmitters/receivers and the control and evaluation device are configured such that the at least one capacitive, micromechanical ultrasonic transducer of the respective ultrasound transmitters or the ultrasound transmitters/receiver emits ultrasonic pulses of a specified frequency and duration in dependence on transmit signals of the control and evaluation device, which pulses are shorter than 100 milliseconds, and in which the at least one capacitive, micromechanical ultrasonic transducer of at least some of the ultrasound receivers or ultrasound transmitters/receivers is respectively configured such that it receives ultrasonic pulses of specified frequency and duration which are shorter than 100 milliseconds and forms corresponding receive signals, and that the control and evaluation device is configured to receive and to process the receive signals.

34. The device according to claim 29, in which at least one of the ultrasound transmitters has at least two capacitive, micromechanical ultrasonic transducers and/or at least two of the ultrasound transmitters respectively have at least one capacitive, micromechanical ultrasonic transducer, and these capacitive, micromechanical ultrasonic transducers are disposed on a chip and respectively have electrodes which are contacted by conductive paths on the respective chip and/or
in which at least one of the ultrasound receivers has at least two capacitive, micromechanical ultrasonic transducers and/or at least two of the ultrasound receivers respectively have at least one capacitive, micromechanical ultrasonic transducer, and these capacitive, micromechanical ultrasonic transducers are disposed on a chip, respectively have electrodes which are contacted by conductive paths on the respective chip
or in which at least one of the ultrasound transmitters/receivers has at least two capacitive, micromechanical ultrasonic transducers and/or at least two of the ultrasound transmitters/receivers respectively have at least one capacitive, micromechanical ultrasonic transducer, and these capacitive, micromechanical ultrasonic transducers are disposed on a chip, and respectively have electrodes which are contacted by conductive paths on the respective chip.

35. The device according to claim 34, in which adjacent ones of the capacitive, micromechanical ultrasonic transducers configured on a chip have a distance between 100 μm and 10 mm in the transport direction and/or a distance between 100 μm and 10 mm transverse to the transport.

36. The device according to claim 34, in which at least one of the capacitive, micromechanical ultrasonic transducers has an extent between 100 μm and 10 mm in the transport direction and/or an extent between 100 μm and 10 mm transverse to the transport direction.

37. The device according to claim 32, in which at least one of the ultrasound transmitters has at least two capacitive, micromechanical ultrasonic transducers and/or at least two of the ultrasound transmitters respectively have at least one capacitive, micromechanical ultrasonic transducer, and these capacitive, micromechanical ultrasonic transducers are disposed on a chip and respectively have electrodes which are contacted by conductive paths on the respective chip and/or
in which at least one of the ultrasound receivers has at least two capacitive, micromechanical ultrasonic transducers and/or at least two of the ultrasound receivers respectively have at least one capacitive, micromechanical ultrasonic transducer, and these capacitive, micromechanical ultrasonic transducers are disposed on a chip, respectively have electrodes which are contacted by conductive paths on the respective chip
or in which at least one of the ultrasound transmitters/receivers has at least two capacitive, micromechanical ultrasonic transducers and/or at least two of the ultrasound transmitters/receivers respectively have at least one capacitive, micromechanical ultrasonic transducer, and these capacitive, micromechanical ultrasonic transducers are disposed on a chip, and respectively have electrodes which are contacted by conductive paths on the respective chip.

38. The device according to claim 37, in which adjacent ones of the capacitive, micromechanical ultrasonic transducers configured on a chip have a distance between 100 μm and 10 mm in the transport direction and/or a distance between 100 μm and 10 mm transverse to the transport.

39. The device according to claim 37, in which at least one of the capacitive, micromechanical ultrasonic transducers has an extent between 100 μm and 10 mm in the transport direction and/or an extent between 100 μm and 10 mm transverse to the transport direction.

40. The device according to claim 32, in which the control and evaluation device is configured to emit transmit signals to at least two different, adjacent ones of the ultrasound transmitters or ultrasound transmitters/receivers at the same time, so that these emit ultrasound with different frequency or pulses of ultrasound with different frequency, and to receive and to process, in particular to accordingly filter, receive signals of the ultrasound receiver forming an ultrasound path with the respective ultrasound transmitter or of the ultrasound transmitter/receiver.

41. The device according to claim 32, in which the control and evaluation device is configured to emit transmit signals to at least one of the ultrasound transmitters or the ultrasound transmitters/receivers such that this emits a sequence of ultrasonic pulses from which at least two successive ones have a different frequency, and to receive and process receive signals of the ultrasound receiver associated with the respective ultrasound transmitter or of the ultrasound transmitter/receiver, to filter these according to the frequencies or the succession of the frequencies of the emitted pulses.

42. The device according to claim 32, in which at least one of the ultrasound transmitters or at least one of the ultrasound transmitters/receivers has at least two capacitive, micromechanical ultrasonic transducers and the ultrasonic transducers of the at least one ultrasound transmitter or ultrasound receiver or ultrasound transmitter/receiver are connected with the control and evaluation device such and the control and evaluation device is configured such that this emits transmit signals to the ultrasonic transducers so that these emit ultrasound with the same frequency, or that this processes the receive signals jointly for a same frequency.

43. The device according to claim 32, in which the control and evaluation device is configured such that it emits such transmit signals to the capacitive, micromechanical ultrasonic transducers that these emit ultrasound with the same frequency and different phase.

44. The device according to claim 32, in which the control and evaluation device is configured to ascertain from the receive signals upon processing these at least one of at least one value which represents the weight per unit area and/or the thickness of a value document, a local weight per unit area-profile or thickness profile and whether a value document for which receive signals were received was transported as a single value document or at least partly overlapping with another value document, and upon ascertaining at least partly overlapping value documents to emit a signal representing a result of the ascertaining.

45. The device according to claim 32, in which the control and evaluation device is configured to recognize, upon processing the receive signals employing the receive signals, edges, leading edges or trailing edges, of a transported value document, and wherein the control and evaluation device is configured to recognize upon processing the receive signals whether and/or when at least one specified edge, the leading edge in the transport direction and/or the trailing edge in the transport direction, of a value document passes a specified location at the transport path, and/or to recognize the position thereof and to emit thereupon a corresponding signal.

46. An apparatus for processing value documents comprising
a feeding device for accepting value documents to be processed,
an output device for outputting or accepting the processed value documents,
a transport device for transporting the value documents from the feeding device along a transport path to the output device and
with at least one device, disposed in the region of a portion of the transport path, for examining the value documents and/or the transport of the value documents which are transported along the transport path, according to claim 29.

47. A method for examining value documents and/or for monitoring the transport of value documents by means of ultrasound, in which
by means of at least one ultrasound transmitter ultrasound is emitted, upon transmit signals, on a value document transported along a transport path and the ultrasound thereupon emanating from the value document is received by means of at least one ultrasound receiver and receive signals are formed, or
by means of at least one ultrasound transmitter/receiver ultrasound is emitted, upon transmit signals, on a value document transported along a transport path the ultrasound thereupon emanating from the value document is received by means of the at least one ultrasound transmitter/receiver and receive signals are formed, wherein the at least one ultrasound transmitter and/or at least one ultrasound receiver or the at least one ultrasound transmitter/receiver have at least one capacitive, micromechanical ultrasonic transducer.

48. The method according to claim 47, in which a device according to any of the preceding claims is employed and the ultrasound transmitters and ultrasound receivers or ultrasound transmitters/receivers of the device are employed as the at least one ultrasound transmitter and the at least one ultrasound receiver or the ultrasound transmitters/receivers as the at least one ultrasound transmitter/receiver, and transmit signals are emitted to the at least one ultrasound transmitter or the at least one ultrasound transmitter/receiver which thereupon emits ultrasound, and upon receiving the formed ultrasound receive signals of the at least one ultrasound receiver or ultrasound transmitter/receiver are received and evaluated.

49. The method according to claim 47, in which the at least one capacitive, micromechanical ultrasonic transducer of at least some of the ultrasound transmitters or ultrasound transmitters/receivers is configured such and transmit signals are formed and emitted such that the at least one capacitive, micromechanical ultrasonic transducer of the respective ultrasound transmitters or the ultrasound transmitter/receiver emits ultrasonic pulses of a specified frequency and duration in dependence on the transmit signals of the control and evaluation device, which pulses are shorter than 100 milliseconds and in which the at least one capacitive, micromechanical ultrasonic transducer of at least some of the ultrasound receivers or ultrasound transmitters/receivers is respectively configured such that it receives ultrasonic pulses of specified frequency and duration which are shorter than 100 milliseconds and forms corresponding receive signals, and the receive signals are received and processed.

50. The method according to claim 48, in which the at least one capacitive, micromechanical ultrasonic transducer of at least some of the ultrasound transmitters or ultrasound transmitters/receivers is configured such and transmit signals are formed and emitted such that the at least one capacitive, micromechanical ultrasonic transducer of the respective ultrasound transmitters or the ultrasound transmitter/receiver emits ultrasonic pulses of a specified frequency and duration in dependence on the transmit signals of the control and evaluation device, which pulses are shorter than 100 milliseconds and in which the at least one capacitive, micromechanical ultrasonic transducer of at least some of the ultrasound receivers or ultrasound transmitters/receivers is respectively configured such that it receives ultrasonic pulses of specified frequency and duration which are shorter than 100 milliseconds and forms corresponding receive signals, and the receive signals are received and processed.

51. The method according to claim 48, in which transmit signals are emitted to at least two different, adjacent ones of the ultrasound transmitters or ultrasound transmitters/receivers, so that these emit ultrasound with different frequency or pulses of ultrasound with different frequency, and receive signals of the ultrasound receiver forming an ultrasound path with the respective ultrasound transmitter or of the ultrasound transmitter/receiver are received and processed, in particular accordingly filtered.

52. The method according to claim 47, in which at least one of the ultrasound transmitters is controlled with transmit signals such that this emits a sequence of ultrasonic pulses from which at least two successive ones have a different frequency, and receive signals of the ultrasound receiver associated with the respective ultrasound transmitter or of the ultrasound transmitter/receiver are received and processed, filtered according to the frequencies or the succession of the frequencies of the emitted pulses.

53. The method according to claim 48, in which at least one of the ultrasound transmitters is controlled with transmit signals such that this emits a sequence of ultrasonic pulses from which at least two successive ones have a different frequency, and receive signals of the ultrasound receiver associated with the respective ultrasound transmitter or of the ultrasound transmitter/receiver are received and processed, filtered according to the frequencies or the succession of the frequencies of the emitted pulses.

54. The method according to claim 48, in which at least one of the ultrasound transmitters and/or ultrasound receivers or ultrasound transmitters/receivers has at least two capacitive, micromechanical ultrasonic transducers, and in which transmit signals are emitted to these capacitive, micromechanical ultrasonic transducers such that these emit ultrasound with the same frequency, or the receive signals are evaluated for a specified same frequency.

55. The method according to claim 48, in which there is ascertained from the receive signals, by means of an evaluation device or the control and evaluation device, at least one value which represents the weight per unit area and/or the thickness of the value document or values which represent the weight per unit area and/or the thickness in dependence on the location.

56. The method according to claim 47, in which upon processing the receive signals are employed to recognize whether and/or when at least one specified edge, the leading edge in the transport direction and/or the trailing edge in the transport direction, of a value document passes a specified location, and/or to recognize the position thereof
